(19) United States
(12) Patent Application Publication
(10) Pub. No.: US 2009/0020979 A1
(43) Pub. Date: Jan. 22, 2009

(54) AUTOMATICALLY DRIVING FORCE RELEASING TYPE ONE WAY ROTATION DRIVING INSTRUMENT

(75) Inventors: Eiichi Genda, Nagoya-shi (JP); Kazushige Ohta, Nagoya-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Japan Labour Health and Welfare Organization, Kawasaki-shi (JP)

(21) Appl. No.: 12/174,823

(22) Filed: Jul. 17, 2008

(30) Foreign Application Priority Data
Jul. 20, 2007 (JP) 2007-189577

(51) Int. Cl. A61G 5/02; A61G 5/10; B62M 1/04; B62M 9/00

(52) U.S. Cl. 280/255; 192/46

(57) ABSTRACT

An automatically driving force releasing type one way rotation driving instrument for a wheelchair includes a one way clutch 50 for transmitting a driving force only when an output shaft 50b is connected to a drive wheel 13 of a wheelchair 10 and an input shaft 50a is driven in the direction in which the wheelchair 10 is moved forwardly, a rope member 35 which is wound around at least one part of an outer periphery of the input shaft 50a of the one way clutch 50, pulling means 32 and 33 for pulling one end of the rope member 35 with respect to a central part thereof in a direction away from the input shaft 50a, and restraining means 36 for restraining the other end of the rope member 35 with respect to the central part thereof from moving in the direction of the input shaft 50a due to pulling with the pulling means 32 and 33.

### CROSS-REFERENCE TO RELATED APPLICATION

This application is related to and claims priority from Japanese patent application No. 2007-189577, filed on Jul. 20, 2007, incorporated herein by reference.

### BACKGROUND OF THE INVENTION

1. Field of the Invention

The present invention relates to a one way rotation driving instrument for automatically releasing a driving force of a moving body and a wheelchair, and, more particularly, to an automatically driving force releasing type one way rotation driving instrument which can be driven with not only upper limbs but also lower limbs.

2. Description of Related Art

Generally, a wheelchair has the arrangement that rear wheels are drive wheels with larger diameters, front wheels are casters with smaller diameters, and hand rims are directly connected to the rear drive wheels so as to be driven by patient's hands. And the rear wheels are provided with a brake device. When the wheelchair is driven by operating the hand rims with upper limbs, a large load is applied to the upper limbs so that it has been reported that shoulders of patients may be injured. The patients using the wheelchairs may be not only the persons whose lower limbs do not move completely, but also the persons who are difficult to walk stably, but have some muscle forces in their lower limbs. Under these circumstances, there can be considered the rotation driving instruments for wheelchairs, which can produce a driving force by moving lower limbs.

One example of the conventional rotation driving instrument for a wheelchair, which can be driven with lower limbs, has the arrangement that two rear wheels are driven to rotate via a crank mechanism by seating on a saddle and stepping on pedals (see publication of unexamined Japanese patent application No. 2000-210337, for example).

And, although not disclosed in any publication, there has been developed in Canada the wheelchair of which rear wheels are driven with pedals, and, upon stopping the operation of the pedals, rotate by inertia with a ratchet mechanism to move forwardly, similarly to bicycles.

And, there is another example which is arranged such that when the driving of the pedals is stopped with a one way clutch mechanism, rear wheels rotate by inertia to move forwardly (see publication of unexamined Japanese patent application No. 2004-147819, for example).

The conventional rotation driving instrument for driving two rear wheels via a crank mechanism by seating on the saddle and stepping on the pedals has noted only the forward driving so that when the device starts moving forwardly, the pedals continue moving even after patient's feet separate from the pedals, which is dangerous. Where feet remain on the pedals, brake is applied to the rear wheels.

In the wheelchair having a drive system using a ratchet mechanism, similarly to bicycles, a drive instrument is complicated to become expensive, and when the wheelchair is moved backwardly by driving a hand rim with fingers of upper limbs, a ratchet is engaged so that pedals are driven to rotate in an opposite direction. Therefore, when the wheelchair is moved backwardly, a clutch for engaging an input shaft with an output shaft has been required to be disengaged manually.

In a small space (such as a lavatory, elevator, etc.), the wheelchair cannot make a U-turn so as to be required to readily move forwardly and backwardly, but it has been very troublesome to manually operate the clutch every time the wheelchair moves forwardly and backwardly.

### SUMMARY OF THE INVENTION

The present invention has been made, considering the above-described problems, and has an object of providing an automatically driving force releasing type one way rotation driving instrument by which, when a foot or hand separates from a pedal, the pedal stops moving, wheels move forwardly by inertia, and friction between a drive mechanism and the wheels (output shafts) disappears to automatically release a connection of the drive mechanism and the wheels.

In order to achieve the above-described objects, according to a first aspect of the present invention, the automatically driving force releasing type one way rotation driving instrument includes a one way clutch for transmitting a driving force only when an output shaft is connected to a drive shaft of a moving body to drive an input shaft in a direction in which the moving body moves forwardly, a rope member which is wound around at least one part of an outer periphery of the input shaft of the one way clutch, pulling means for pulling one end of the rope member with respect to a central part thereof, which is wound around the outer periphery of the input shaft, in a direction away from the input shaft, and restraining means for restraining the other end of the rope member with respect to the central part thereof from moving in a direction of the input shaft due to pulling with the pulling means, and the input shaft is driven to rotate in one direction due to friction resistance between the rope member wound around the input shaft of the one way clutch and the input shaft, which is generated with pulling of the pulling means and restraining of the restraining means, with a pulling force of the pulling means via the rope member such that when the pulling force becomes zero, the friction resistance becomes zero to automatically release the transmission of the driving force.

With this arrangement, when the input shaft of the one way clutch is driven to rotate in a specific direction by pulling the rope member with the pulling means, the drive shaft is driven to rotate in the direction in which the moving body moves forwardly. When the speed of rotation of the input shaft with the pulling means is low, the drive shaft rotates by inertia, whereas when the speed of rotation of the input shaft is high, the drive shaft rotates at an accelerated speed. When the speed of rotation of the input shaft with the pulling means is low, the drive shaft rotates by inertia so that the pulling means is prevented from continuing operating due to the rotation of the drive shaft, and accordingly, this arrangement is safe. And where the rope member is not pulled with the pulling means, the friction resistance between the rope member and the input shaft is small so that the driving force is automatically cut off, and by driving the drive shaft manually, the backward movement, turning movement and fine adjustment of position can be carried out.

In order to achieve the above-described objects, according to a second aspect of the present invention, the automatically driving force releasing type one way rotation driving instrument includes a one way clutch for transmitting a driving force only when an output shaft is connected to a drive wheel of a wheelchair to drive an input shaft in a direction in which the wheelchair moves forwardly, a rope member which is wound around at least one part of an outer periphery of the input shaft of the one way clutch, pulling means for pulling one end of the rope member with respect to a central part thereof, which is wound around the outer periphery of the input shaft, in a direction away from the input shaft, and restraining means for restraining the other end of the rope member with respect to the central part thereof from moving in a direction of the input shaft due to pulling with the pulling means, and the input shaft is driven to rotate in one direction due to friction resistance between the rope member wound around the input shaft of the one way clutch and the input shaft, which is generated with pulling of the pulling means and restraining of the restraining means, with a pulling force of the pulling means via the rope member such that when the pulling force becomes zero, the friction resistance becomes zero to automatically release the transmission of the driving force.

With this arrangement, when the input shaft of the one way clutch is driven to rotate in a specific direction by pulling the rope member with the pulling means, the drive wheel is driven to rotate in the direction in which the wheelchair moves forwardly. When the speed of rotation of the input shaft with the pulling means is low, the drive wheel rotates by inertia, whereas when the speed of rotation of the input shaft is high, the drive wheel rotates at an accelerated speed. When the speed of rotation of the input shaft with the pulling means is low, the drive wheel rotates by inertia so that the pulling means is prevented from continuing operating due to the rotation of the drive wheel, and accordingly, this arrangement is safe. And when the rope member is not pulled with the pulling means, the friction resistance between the rope member and the input shaft is small so that the driving force is automatically cut off, and by manually driving the drive wheel without operating the clutch, the backward movement, turning movement and fine adjustment of position can be carried out.

And according to a third aspect of the present invention, the pulling means can be provided with a pedal support frame which is pivotally supported with a frame of a wheelchair, and a pedal which is attached to one end of the pedal support frame, and the restraining means can be provided with a tension spring adapted to secure the other end of the rope member to the frame of the wheelchair in a stretched condition.

With this arrangement, the rope member which is wound around the input shaft of the one way clutch, and the pedal support frame which pivots when a patient steps on a pedal, are connected to each other, and when the pedal is stepped on, the pedal support frame pivots forwardly and the rope member is pulled in a direction away from the input shaft. Since the other end of the rope member which is wound around the input shaft is secured to the frame via the tension spring so that the friction resistance between the rope member and the input shaft increases to rotate the input shaft in the direction of the forward movement of the wheelchair. When the patient looses his foot from the pedal, or decreases his stepping force on the pedal, the friction resistance between the rope member and the input shaft decreases so that the driving force is automatically cut off, and by manually driving the drive wheels, the backward movement, turning movement and fine adjustment of position of the wheelchair can be carried out.

Where the rope member is not pulled with the pulling member, the friction resistance between the rope member and the input shaft is small so that the driving force is automatically cut off (the connection of the pulling means and the input shaft is automatically cut off), and consequently, the backward movement, turning movement and fine adjustment of position can be carried out by manually driving the drive wheels without providing such lock releasing means as has been conventionally required.

Other features and characteristics of the present invention will become apparent upon consideration of the following description and the appended claims with reference to the accompanying drawings, all of which form a part of this specification.

### BRIEF DESCRIPTION OF THE DRAWINGS

FIG. 1 is a perspective view of a wheelchair provided with one embodiment of an automatically driving force releasing type one way rotation driving instrument in accordance with the present invention;

FIG. 2 is a view seen from the section taken along line A-A of FIG. 1; and

FIG. 3 is an end view of the section taken along line C-C of FIG. 2.

### DETAILED DESCRIPTION OF THE PREFERRED EMBODIMENTS

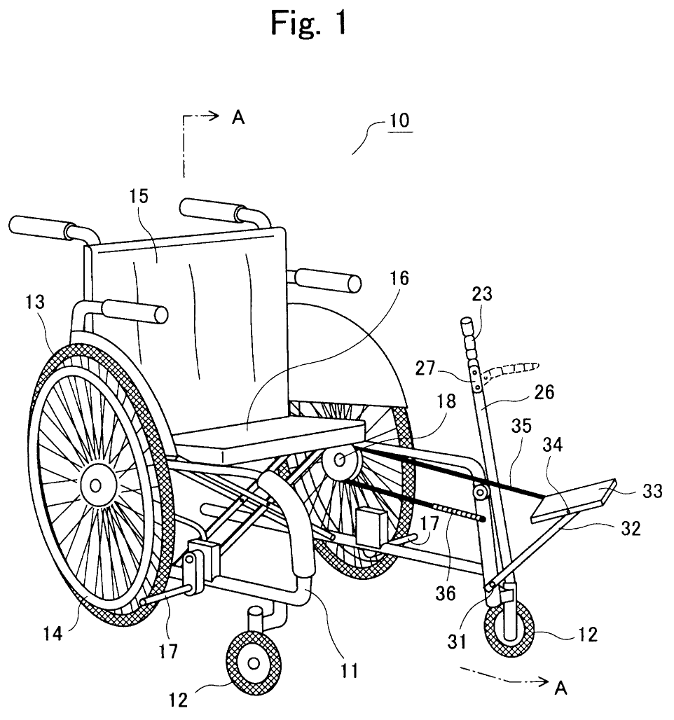

Hereinafter, one embodiment of the present invention will be explained with reference to FIGS. 1 through 3.

FIG. 1 is a perspective view of a wheelchair provided with an automatically driving force releasing type one way rotation driving instrument in accordance with the present invention. A wheelchair 10 has a frame 11 composed of pipes, similarly to normal wheelchairs, and front wheels are composed of casters 12, each having a smaller diameter, whereas rear wheels are composed of drive wheels 13, each having a larger diameter. A hand rim 14 is directly connected to the drive wheel 13, and by operating left and right hand rims 14, the left and right drive wheels 13 are driven to rotate such that the wheelchair 10 can move forwardly and backwardly and turn leftwardly and rightwardly. A canvas is stretched between a left side portion and a right side portion of the frame 11 to define a seat back 15 and a seat 16. And a brake device 17 is attached to a lower part of the right side portion of the frame 11 in front of the right drive wheel 13 so as to apply a brake thereto.

A caster connection shaft 26 is directly connected to the left caster 12 to transmit the turning of the caster 12 as the turning of the caster connection shaft 26. A handlebar 23 is connected to the caster connection shaft 26 with a connecting structure 27 which can tilt forwardly and backwardly by 90° with respect to the caster connection shaft 26, namely, 180° in total. And, the connecting structure 27 is biased with a spring (not shown) which is provided inside the connecting structure 27 such that the handlebar 23 is held upright in a free state thereof.

When a patient operates the wheelchair 10 using the left and right hand rims 14, his fingers separate from the handlebar 23. Therefore, the handlebar 23 is held upright with the biasing force of the spring (not shown), and only turns round on its axis in position so as not to obstruct movements of the patient. When the patient is going to drive the wheelchair 10 with his lower limbs, the moving direction of the wheelchair can be controlled by tilting the handlebar 23 in either direction by 90°, as shown in imaginary lines, and adjusting the turning position of the caster connection shaft 26. With the thus arranged handlebar 23, there can be effected the operational advantage that where a patient's hand is away from a handle, a single axis (23, 26, 27) which is held upright with the spring merely turns round on its axis so as not to obstruct patient's motions.

A pedal support frame 32 is attached to a lower part of the left side portion of the frame 11 so as to pivot on a pivot shaft 31. A pedal 33 for placing a patient's foot thereon is axially supported with a tip end of the pedal support frame 32 so as to turn round a shaft 34. One end of a rope member 35 adapted to drive a drive shaft 18 with the pivoting movement of the pedal support frame 32 is connected to an upper end of the pedal support frame 32.

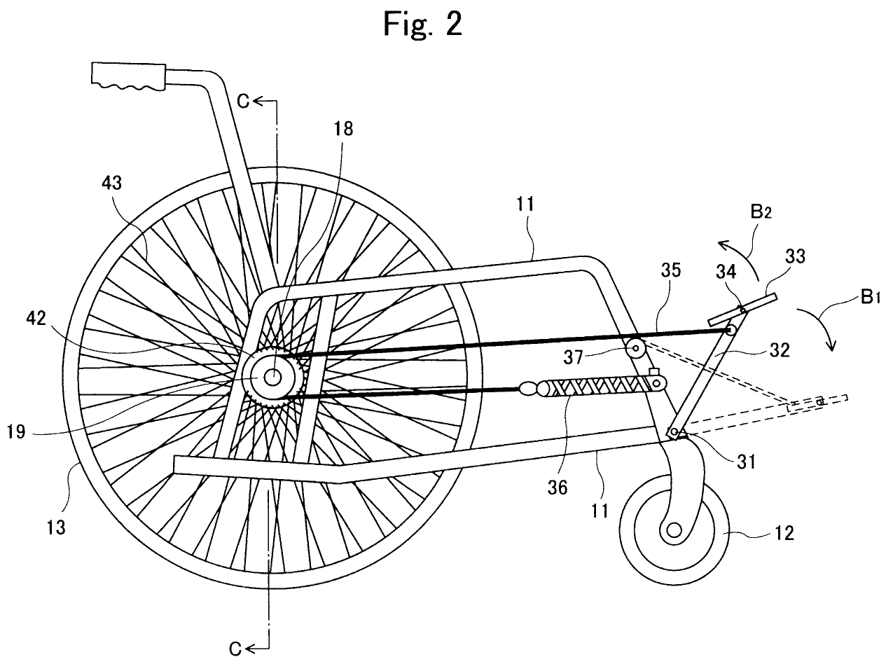

FIG. 2 is a view seen from the section taken along line A-A of FIG. 1. The caster 12 is located on a front side of the wheelchair, and the rear drive wheel 13 is supported with a center hub 42 via many spokes 43. A drum 19 is secured to an outer periphery of the drive shaft 18, and about a longitudinal center of the rope member 35 is wound around the drum 19. One end of the rope member 35 is secured to the pedal support frame 32 which is pivotally supported with the pivot shaft 31 on the lower and front side of the frame 11. The other end of the rope member 35 is secured to the lower and front side of the frame 11 via a tension spring 36. A one way clutch (not shown) is assembled inside the hub 42 such that the drive shaft 18 rotates integrally with an input shaft of the one way clutch. The rope member 35 is wound on the side of an outer periphery of the input shaft of the one way clutch via the drum 19 and the drive shaft 18.

The rope member 35 is composed of a wire rope of stainless steel, for example, and its length inclusive of the length of the tension spring 36 in a free state is selected such that, as shown in FIG. 2, the rope member 35 does not become loose and the friction resistance between the rope member 35 and the drum 19 becomes approximately zero when the pedal support frame 32 tilts at about 45 degree to the horizon. Reference numeral 37 designates a guide roller for the rope member 35.

When the pedal 33 is stepped on with a foot in the direction of arrow B1, the pedal support frame 32 pivots forwardly to pull the rope member 35 in a direction away from the drive shaft 18. Thus, the pedal support frame 32 and the pedal 33 define “pulling means”.

When the rope member 35 is pulled, the tension spring 36 stretches to restrain the other end of the rope member 35 from moving in the direction of the drive shaft 18 with the biasing force of the spring 36. Thus, the tension spring 36 defines “restraining means”.

By moving the pedal 33 in the direction of arrow B2, the pedal can be folded so as not to obstruct the patient upon getting on and off the wheelchair.

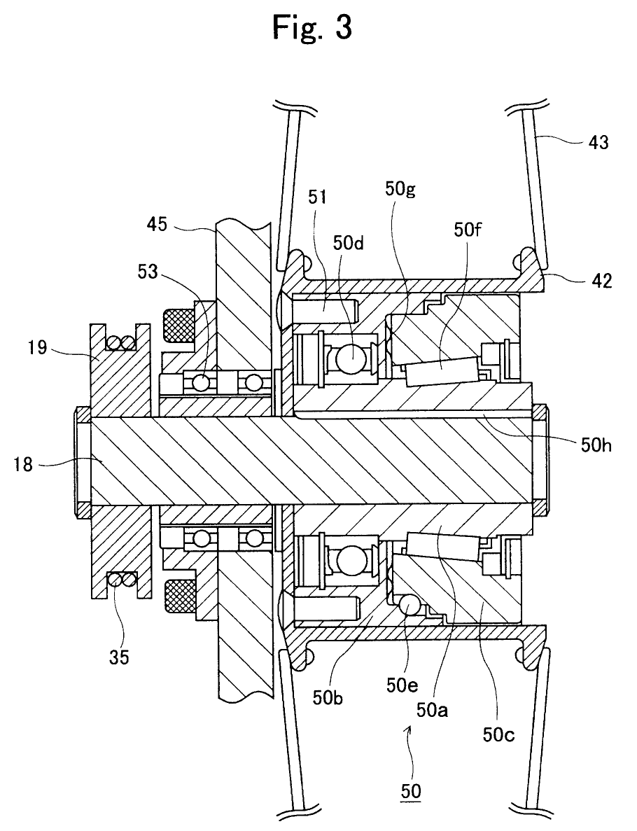

FIG. 3 is an end view of the section taken along line C-C of FIG. 2. One way clutch 50 is assembled inside the hub 42 of the drive wheel 13, and is secured to the hub 42 with screws 51. The one way clutch 50 includes an inner ring 50a, a first outer ring 50b and a second outer ring 50c as main elements. The first outer ring 50b is rotatably supported with a radial bearing 50d relative to the inner ring 50a. A ball coupling piece 50e is provided such that the second outer ring 50c moves freely in the axial direction relative to the first outer ring 50b and rotates in the rotating direction integrally with the first outer ring 50b. More specifically, in a free state, a roller coupling piece 50f cuts into a wedge-shaped space with a biasing force of a wave spring 50g to lock the inner ring 50a and the second outer ring 50c, thereby integrally rotating them in one rotating direction, and in the other rotating direction, the roller coupling piece 50f is unlocked so that the second outer ring 50c freely rotates relative to the inner ring 50a.

The left side drive wheel 13 of the wheelchair 10 is rotatably supported with the frame 11 via the hub 42, the first outer ring 50b, the radial bearing 50d and the inner ring 50a of the one way clutch 50, the drive shaft 18, a bearing 53, and a stay 45. The drum 19 having U shape groove in section is secured to an outer periphery of about a left end of the drive shaft 18, and the rope member 35 is wound around the drum 19.

The operation of the thus arranged wheelchair will be explained. When a patient sits on the wheelchair and starts stepping down on the pedal 33 with his lower limb, one end of the rope member 35 is pulled in a direction away from the drive shaft 18. As a result, the tension spring 36 connected to the other end of the rope member 35 is stretched to restrain the other end of the rope member 35 from moving in the direction of the drive shaft 18 with the biasing force of the spring 36. Consequently, the friction resistance between the part of the rope member 35, which is wound around the drum 19, and the drum 19 increases in proportion to the stroke of stepping of the pedal 33, and the drive shaft 18 is driven to rotate in a forward moving (clockwise) direction. When the drive shaft 18 is driven to rotate in the forward moving (clockwise) direction, the roller coupling piece 50f locks so that the inner ring 50a as an input shaft, the first outer ring 50b, and the second outer ring 50c integrally rotate with each other to drive the drive wheel 13 forwardly.

When the pedal 33 is stepped down, and the speed adapted to rotate the drive shaft 18 is lower than the rotating speed of the drive wheel 13, the drive shaft 18 runs idle so that the drive wheel 13 rotates by inertia. When the pedal 33 is stepped down, and the speed adapted to rotate the drive shaft 18 is higher than the rotating speed of the drive wheel 13, the drive wheel 13 is rotated at an accelerated speed with a rotation driving force of the drive shaft 18. Even where there exists friction resistance between the drive shaft 18 and the rope member 35 to drive the drive shaft 18 to rotate counterclockwise (by raising the pedal 33 in the direction opposite to arrow B₁), the roller coupling piece 50f is unlocked so that the second outer ring 50c freely rotates relative to the inner ring 50a (input shaft). As a result, the drive shaft 18 merely runs idle counterclockwise, whereas the drive wheel 13 continues rotating by inertia.

When the lower limb is separated from the pedal 33, the friction resistance between the part of the rope member 35, which is wound around the drum 19, and the drum 19 becomes approximately zero, and consequently, the driving force is automatically released (the connection of the drum 19 and the rope member 35 is automatically cut off) so that the forward movement and the backward movement can be carried using the hand rims. In order to move backwardly, for example, manually using the hand rims, the lower limb may be separated from the pedal 33. When the lower limb is separated from the pedal 33, a forward driving force is not applied to the drive shaft 18 so that the backward movement can be carried out manually using the hand rims. When the drive wheel 13 rotates counterclockwise, the roller coupling piece 50f locks so that the inner ring 50a as the input shaft, the first outer ring 50b and the second outer ring 50c rotate integrally, and the drive shaft 18 rotates counterclockwise, but the friction resistance between the rope member 35 and the drum 19 is nearly zero so that the rotation of the drive shaft 18 is not transmitted to the pedal 33, and accordingly, this arrangement is safe.

While the invention has been described in connection with what are considered to be the preferred embodiments, it is to be understood that the invention is not limited to the disclosed embodiments, but, on the contrary, is intended to cover various modifications and equivalent arrangements included within the spirit and scope of the appended claims.

What is claimed is:

1. An automatically driving force releasing type one way rotation driving instrument, comprising:
a one way clutch for transmitting a driving force only when an output shaft is connected to a drive shaft of a moving body to drive an input shaft in a direction in which the moving body moves forwardly;
a rope member wound around at least one part of an outer periphery of said input shaft of said one way clutch;
pulling means for pulling one end of said rope member with respect to a central part thereof, which is wound around said outer periphery of said input shaft, in a direction away from said input shaft; and
restraining means for restraining the other end of said rope member with respect to said central part thereof from moving in a direction of said input shaft due to pulling with said pulling means, said input shaft being driven to rotate in one direction with a pulling force of said pulling means via said rope member due to friction resistance between said rope member wound around said input shaft of said one way clutch and said input shaft, which is generated with pulling of said pulling means and restraining of said restraining means, such that when said pulling force becomes zero, said friction resistance becomes zero to automatically release transmission of the driving force.

2. An automatically driving force releasing type one way rotation driving instrument for a wheelchair, comprises:
a one way clutch for transmitting a driving force only when an output shaft is connected to a drive wheel of the wheelchair to drive an input shaft in a direction in which the wheelchair moves forwardly;
a rope member wound around at least one part of an outer periphery of said input shaft of said one way clutch;
pulling means for pulling one end of said rope member with respect to a central part thereof, which is wound around said outer periphery of said input shaft, in a direction away from said input shaft; and
restraining means for restraining the other end of said rope member with respect to said central part thereof from moving in a direction of said input shaft due to pulling with said pulling means, said input shaft being driven to rotate in one direction with a pulling force of said pulling means via said rope member due to friction resistance between said rope member wound around said input shaft of said one way clutch and said input shaft, which is generated with pulling of said pulling means and restraining of said restraining means, such that when said pulling force becomes zero, said friction resistance becomes zero to automatically release transmission of the driving force.

3. An automatically driving force releasing type one way rotation driving instrument for a wheelchair as claimed in claim 2, wherein
said pulling means includes a pedal support frame which is pivotally supported with a frame of the wheelchair, and a pedal which is attached to one end of said pedal support frame, and
said restraining means includes a tension spring adapted to secure said the other end of said rope member with respect to said central part to the frame of the wheelchair in a stretched condition.
